(19) United States
(12) Patent Application Publication
(10) Pub. No.: US 2008/0217990 A1
(43) Pub. Date: Sep. 11, 2008

(54) Axle attachment for pallet truck

(76) Inventor: David Bruce Parry, Kenilworth (GB)

Correspondence Address: Houston IP Department;JACKSON WALKER L.L.P., 1401 McKinney St., Suite 1900, Houston, TX, 77010, US

(21) Appl. No.: 12/001,233

(22) Filed: Dec. 11, 2007

(30) Foreign Application Priority Data
Dec. 11, 2006 (GB) GB 0624686.2

(51) Int. Cl. B60B 35/02

(52) U.S. Cl. 301/125

(57) ABSTRACT

A pallet truck axle bar (10) comprises an elongate member (12) having at opposed ends thereof a wheel assembly (14). The elongate member (12) is provided between the wheel assemblies with mounting points (36) to enable the bar (10) to be connected to the frame of a pallet truck in place of the fork rollers of the pallet truck, wherein the length of the elongate member (12) is greater than the width of the pallet fingers of the pallet truck.

### CROSS REFERENCE TO RELATED APPLICATION

This application claims priority to Great Britain Application No. GB 0624686.2 filed Dec. 11, 2006.

### BACKGROUND OF THE INVENTION

The present invention relates to an axle bar for a pallet truck.

A pallet truck is a known device which is utilized to enable laden pallets to be moved over smooth surfaces, for example in a warehouse. Such a truck typically comprises a wheeled “U” shaped frame, similar in shape to that of the fork of a fork-lift truck upon which are provided a pair of pallet fingers capable of being elevated. The frame is provided with wheels and rollers spaced in a tricycle arrangement. The tricycle arrangement comprises a roller provided on the underside of each fork, and a third set of wheels or rollers provided at the root of the fork on a member extending therebetween. The third set of wheels are typically pivotable in the manner of a castor so as to enable the truck to be moved over a surface in any given direction.

Disposed between the frame and the pallet fingers is a hydraulic ram which may be extended so as to elevate the pallet fingers. Typically the hydraulic ram of such a pallet truck enables the pallet fingers to be raised and lowered within a range of around 120 mm. In use the frame and pallet fingers are positioned under a load and the ram extended so that the load is lifted by the fingers. An operator can subsequently manoeuvre the pallet truck by a handle thereof so as to move the load to a desired location. High lift pallet trucks having an elevation range greater than 120 mm are also available. Such high lift trucks are commonly referred to as stacking trucks.

The tricycle arrangement of the wheels of the pallet truck can lead to stability problems, especially in instances where the truck is used to lift rolling or unstable items. For certain uses the pallet fingers of the pallet truck may be provided with a low friction surface, such as a roller bed, to assist in the loading and unloading of items. The presence of a low friction surface increases the possibility of a load shifting relative to the pallet fingers when the truck is moved and hence destabilizing the truck as a whole.

In order to address this stability issue the third set of wheels or rollers may be repositioned outwardly from the front to rear centreline of the truck such that a wheel or roller is provided outboard of the frame on either side thereof. While the repositioning of the third set of wheels or rollers increases the stability of the truck it will be appreciated that the track width of the third set of wheels or rollers is greater than the track width of the fork rollers.

According to a first aspect of the present invention there is provided an axle bar comprising an elongate member having at opposed ends thereof a wheel assembly, the elongate member being provided between the wheel assemblies with mounting points to enable the bar to be connected to the frame of a pallet truck in place of the fork rollers of the pallet truck, wherein the length of the elongate member is greater than the width of the pallet fingers of the pallet truck.

The axle bar of the present invention provides a simple and easily installed way of increasing the track width of a pallet truck across the pallet fingers thereof in order to enhance the stability of the pallet truck and to lower rolling resistance.

The axle bar may be provided with a stabiliser. The stabiliser may take the form of a roller which is mounted to the elongate member intermediate the wheel assemblies. In a preferred embodiment the stabiliser roller comprises a lead in roller assembly removed from the underside of a pallet fork of a pallet truck. The axle bar may be provided with a plurality of such stabilisers.

The rotational axes of the wheel assemblies are preferably aligned with the longitudinal axis of the elongate member. The mounting points of the axle bar are preferably configured so as to fit to the fork roller brackets of the pallet truck. Each mounting point preferably includes a member having a bore extending therethrough. The member has a width which is substantially equal to that of a fork roller such that the member is receivable in the fork roller mounting. Typically, the fork roller is mounted to a forked bracket. The mounting point member may thus be received by the forked bracket and an axle member, such as a pin, inserted through the bore and the bracket to retain the axle bar.

According to a second aspect of the present invention there is provided a pallet truck having an axle bar of the type described with reference to the first aspect.

An embodiment of the present invention will now be described with reference to the accompanying drawings in which:

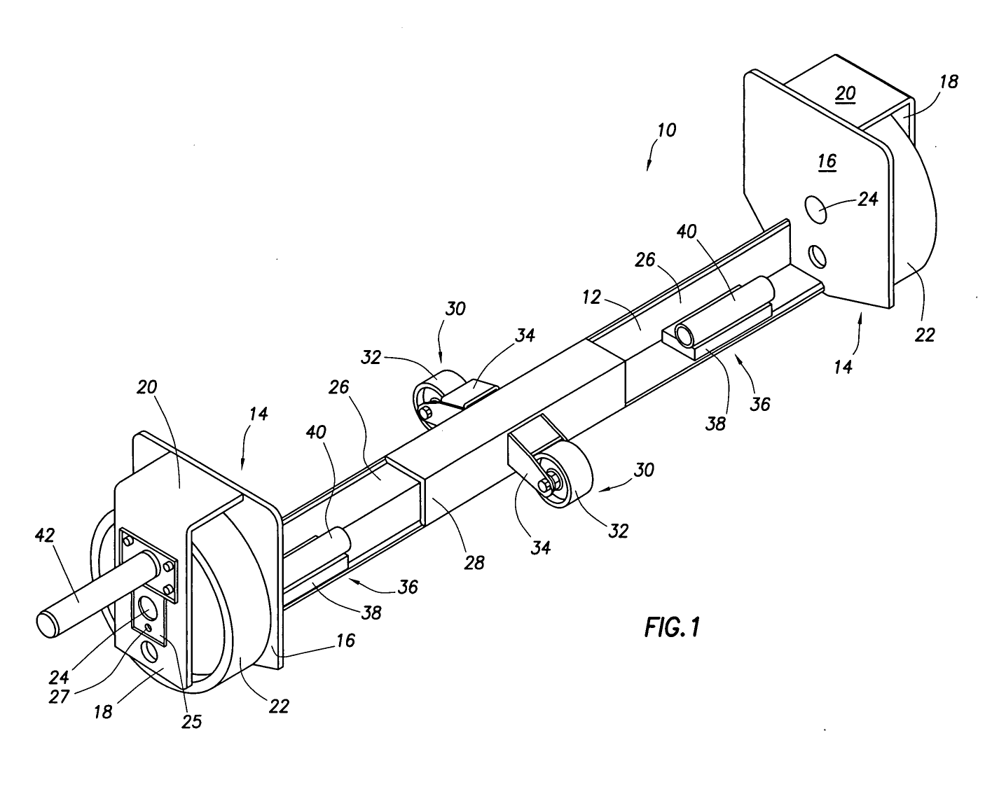

FIG. 1 shows a perspective view of an axle bar according to the present invention;

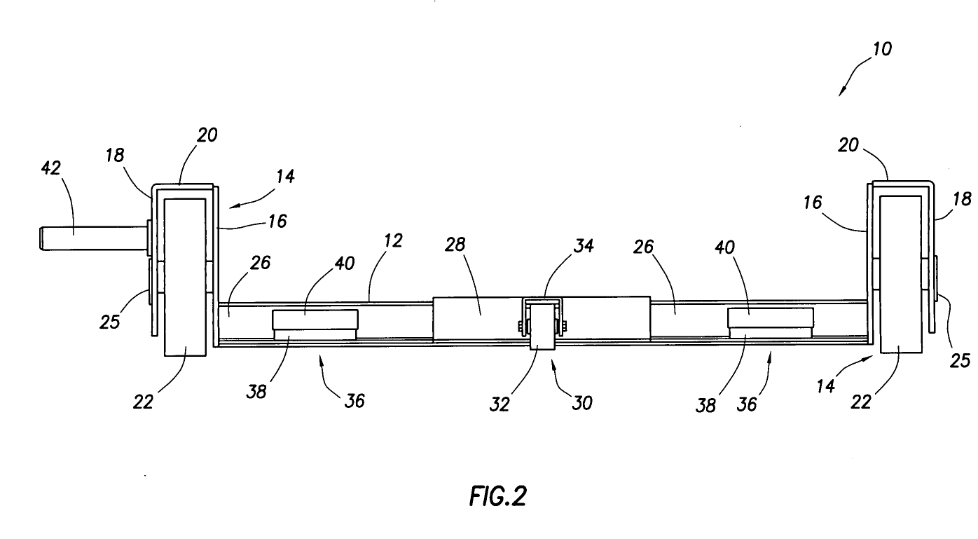

FIG. 2 shows a front view of the axle bar of FIG. 1; and

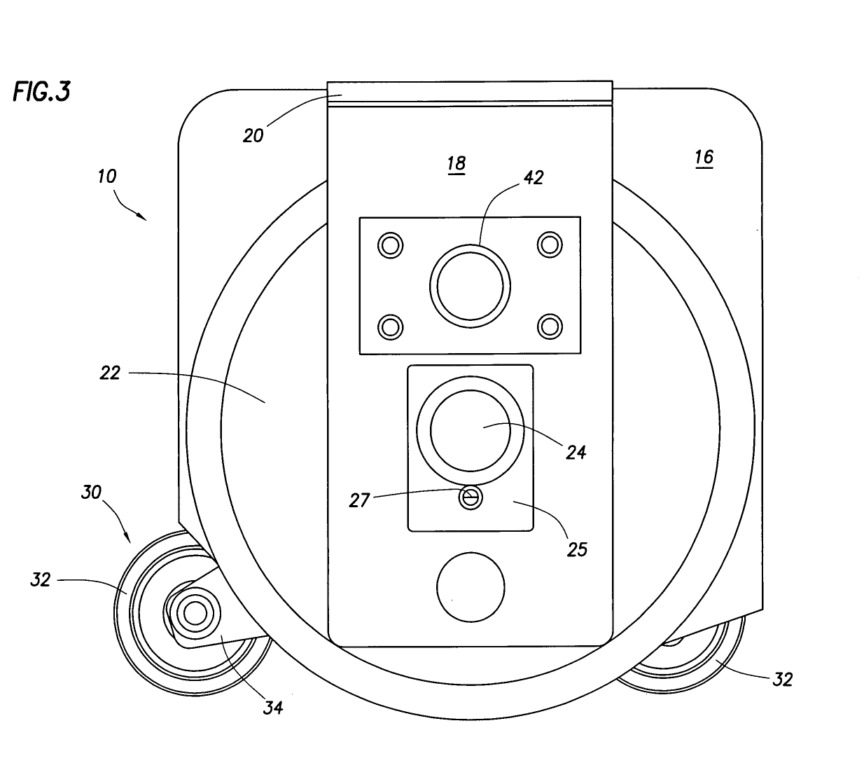

FIG. 3 shows an end view of the axle bar of FIG. 1.

Referring to the drawings there is shown an axle bar generally designated 10. The bar 10 includes a transverse member 12 which extends between opposed wheel assemblies 14. Each wheel assembly 14 comprises a back plate 16, a front plate 18, a bridging member 20 and a wheel 22. The plates 16,18 and bridging member 20 define a substantially “U” shaped bracket which surrounds the wheel 22. The wheel 22 of each assembly 14 is rotatably mounted to an axle 24 which is carried by the front and back plates 16,18. The axle 24 is mounted in appropriately configured bearings of the plates 16,18. A keeper plate 25 retained by a grub screw 27 is utilised to maintain the axle 24 in position. The length of the transverse member 12 is greater that the width of the frame and pallet forks of the pallet truck to which the bar 10 is intended to be fitted. As such, the wheels 22 in use are provided to either side of the frame and pallet forks.

The transverse member 12 is substantially “L” shaped in cross-section at it's outer portions 26 and is provided with a box section portion 28 at its midway point. The box-section portion 28 is provided with a pair of stabilising rollers, generally designated 30, which are provided on opposing sides thereof. Each roller 30 comprises a roller member 32 and a bracket 34 Each outer portion 26 of the transverse member 12 is provided with a mounting point 36 which, in use, enables the axle bar 10 to be fitted to a pallet truck. In the embodiment shown each mounting point 36 comprises a base 38 fixed to the transverse member 12 and a tube 40. The tube 40 is fixed to the base 38 and is axially aligned with the transverse member 12. In use, an axle member, such as a pin, can be inserted through the tube 40 and mounting feature a pallet truck frame in order to connect the axle bar 10 to the frame.

The mounting features of the pallet truck frame to which the axle bar 10 is connectable are defined by forked brackets to which the fork rollers are usually mounted. In order to fit the bar 10 to a pallet truck the fork rollers are removed and the bar 10 mounted to fork roller brackets. The length of the tube 40 is substantially equal to the width of a fork roller and as such, the tube is readily receivable within a fork roller bracket Advantageously, the stabilisers 30 may comprise lead in roller assemblies which have been removed from the underside of the pallet fingers.

In the embodiment shown the rotational axes of the wheels 22 are aligned with the longitudinal axis of the of the transverse member 12. It will be understood that the shape and size of the back plates 16 may be altered, as may the position of the transverse member 12 relative to the back plates and/or the position of each axle 24 between the plates 16,18. As such, the position of the rotational axes of the wheels 22 may be moved relative to the longitudinal axis of the transverse member 12. While two stabilising rollers 30 are shown, it will be appreciated that a greater or lesser number my be provided depending upon the intended service parameters of the pallet truck to which the bar 10 is fitted.

It will be appreciated that the diameter of each wheel 22 is greater than the diameter of the fork roller it replaces. The wheels 22 are of equal diameter and each may have a diameter in the range of 170 mm to 250 mm, although larger diameter wheels may be used if required. The front plate 18 of one of the wheel assemblies 14 is provided with a cylindrical projection generally designated 42. The projection 42, in use, may co-operate with a guide mechanism which is configured to guide the axle bar 10 and the pallet truck to which it is fitted along a predetermined path.

While the axle bar 10 is described above as being suitable for use with a pallet truck which has had the track of its third set of wheels widened, the axle bar 10 may equally e fitted to a pallet truck having the usual narrow track arrangement for the third set of wheels.

1. A pallet truck axle bar comprising an elongate member having at opposed ends thereof a wheel assembly, the elongate member being provided between the wheel assemblies with mounting points to enable the bar to be connected to the frame of a pallet truck in place of the fork rollers of the pallet truck, wherein the length of the elongate member is greater than the width of the pallet fingers of the pallet truck.

2. An axle bar as claimed in claim 1, wherein the axle bar is provided with a stabiliser which comprises a roller mounted to the elongate member intermediate the wheel assemblies.

3. An axle bar as claimed in claim 2, wherein the stabiliser roller comprises a lead in roller assembly removed from the underside of a pallet fork of a pallet truck.

4. An axle bar as claimed in claim 2, wherein the axle bar is provided with two stabilisers, each of which is positioned on an opposing side of the elongate member.

5. An axle bar as claimed in claim 1, wherein the rotational axes of the wheel assemblies are aligned with the longitudinal axis of the elongate member.

6. An axle bar as claimed in claim 1, wherein the mounting points of the axle bar are configured so as to fit to the fork roller brackets of a pallet truck.

7. An axle bar as claimed in claim 6, wherein each mounting point includes a member having a bore extending therethrough, the member having a width which is substantially equal to that of a fork roller such that the member is receivable in the fork roller mounting.
